(19) United States
(12) Patent Application Publication
(10) Pub. No.: US 2019/0073479 A1
(43) Pub. Date: Mar. 7, 2019

(54) TRUST FAILURE ALERT IN COMMUNICATIONS

(71) Applicant: NOKIA SOLUTIONS AND NETWORKS OY, Espoo (FI)

(72) Inventors: Ian Justin OLIVER, Söderkulla (FI); Shankar LAL, Espoo (FI)

(21) Appl. No.: 16/083,535

(22) PCT Filed: Mar. 10, 2016
(86) PCT No.: PCT/EP2016/055077

§ 371 Date: Sep. 10, 2018

(51) Int. Cl. G06F 21/57; H04L 9/08; G06F 9/455

(52) U.S. Cl. CPC G06F 21/575; G06F 21/572; G06F 2009/45595; G06F 9/45558; H04L 9/0897

(57) ABSTRACT

A computerized method is disclosed for announcing that a failure of a trusted boot procedure has occurred. The method comprises performing, in a computing device (102), the steps of detecting a failure of a trusted boot procedure of the computing device (102), and, in response to the detecting, transmitting a trust failure message via a network (503). The trust failure message is generated, in the computing device (102), by utilizing a launch control policy of a trusted platform module (501) to integrate the trust status of the computing device (102) into the trust failure message, such that the computing device (102) remains in a trusted state.

### TECHNICAL FIELD

The present invention relates to communications.

### BACKGROUND

Trusted platform module (TPM) is a standard for secured cryptoprocessors. TPM enables providing a dedicated microprocessor for securing hardware by integrating cryptographic keys into devices. Launch control policies (LCP) allow a machine to partially boot in an untrusted state but with potentially limited capabilities, i.e. to react in a predefined manner to a specific trust failure, which may include continuing boot, booting a kernel with specific properties, booting a specific kernel, etc. This may enable detection of the trust failure by remote attestation (e.g. CIT by Intel, open attestation, etc.) but requires that the machine is brought to a state where network connections are manageable by a running untrusted operating system. The trust failure detection may be based on running the system in an untrusted state.

### BRIEF DESCRIPTION

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following, the invention will be described in greater detail by means of preferred embodiments with reference to the accompanying drawings, in which

FIG. 1 illustrates a wireless communication system to which embodiments of the invention may be applied;

FIG. 2 illustrates a signalling diagram of a procedure for a failure trust alert according to an embodiment of the invention;

FIGS. 3 and 4 illustrate exemplary computing device architectures;

FIG. 5 illustrates a blocks diagram of apparatuses according to an embodiment of the invention;

FIGS. 6 and 7 illustrate exemplary processes for the failure trust alert according to an embodiment of the invention.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Further-more, words “comprising” and “including” should be understood as not limiting the described embodiments to consist of only those features that have been mentioned and such embodiments may contain also features/structures that have not been specifically mentioned.

Embodiments described may be implemented in a communication system, such as a local area network (LAN), intranet, internet, extranet, wireless LAN (WLAN), Ethernet, TokenRing, SNA, serial port, universal mobile telecommunication system (UMTS, 3G), beyond-3G, 4G, long term evolution (LTE), LTE-advanced (LTE-A), and/or 5G system. The present embodiments are not, how-ever, limited to these systems. The embodiments are not restricted to the system given as an example but a person skilled in the art may apply the solution to other communication systems provided with necessary properties.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or cloud data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent. Some other technology advancements probably to be used are software-defined networking (SDN), big data, and IP-based networks, which may change the way networks are being constructed and managed.

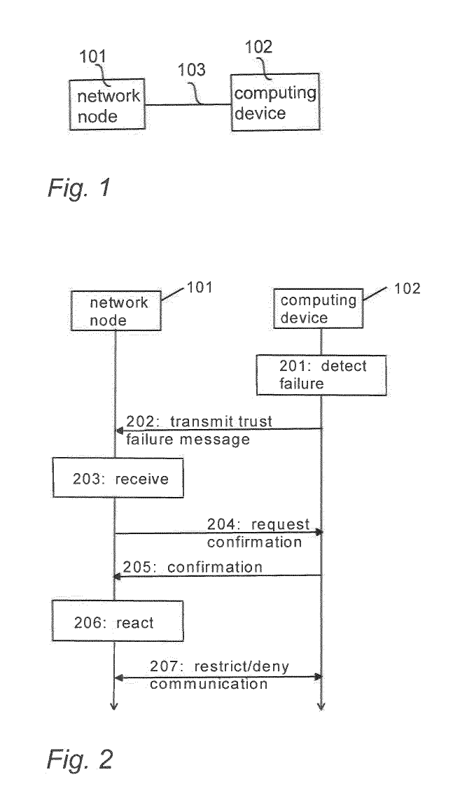

FIG. 1 illustrates an example of a communication system to which embodiments of the invention may be applied. A communication network, such as the local area network (LAN), may comprise at least one network element, such as a network element 101. The network element 101 may be a management and operations (MANO) node NE1 that may comprise or may be connected (directly or indirectly) to a component such as an SDN controller, virtual machine (VIM), orchestrator, security orchestrator, switch, router, and/or cloud security director. The network element 101 may be connected to at least one computing device 102 via a network connection 103. The at least one computing device 102 may comprise a desktop computer, mobile phone, smart phone, tab-let computer, laptop, terminal device, server and/or any other device used for user communication with the communication network. The communication system of FIG. 1 may support machine type communication (MTC). MTC may enable providing service for a large amount of MTC capable devices, such as the at least one computing device 102.

Trusted computing provided by TPM (trusted platform module) is a boot time technology for attesting to the state of a system by checking the cryptographic signatures of BIOS, host operating system and/or other components. Failure of trust at boot time typically means that a machine does not boot. Each component may be trusted by some part of the stack (e.g. maybe a BIOS configuration is untrusted); if any part fails then the system is considered untrusted.

Having a trusted machine fail the trusted boot procedures, either at boot time or potentially at run-time, means that some kind of a security fault, e.g. root-kit, misconfiguration etc. has been introduced. If said machine exists within a cloud environment, this may become a vector for other security attacks. To detect that, the machine typically needs to boot to a stage where the machine is able to report the trust failure (e.g. by making available services to remote attestation), or, not to boot at all and assume that the trust failure is detected through some other means. If the machine does not boot, some kind of a boot procedure is to take place in order to establish the fault within the machine. This may include some kind of an external procedure e.g. via a management interface. How-ever, this may imply usage of untrusted software internally.

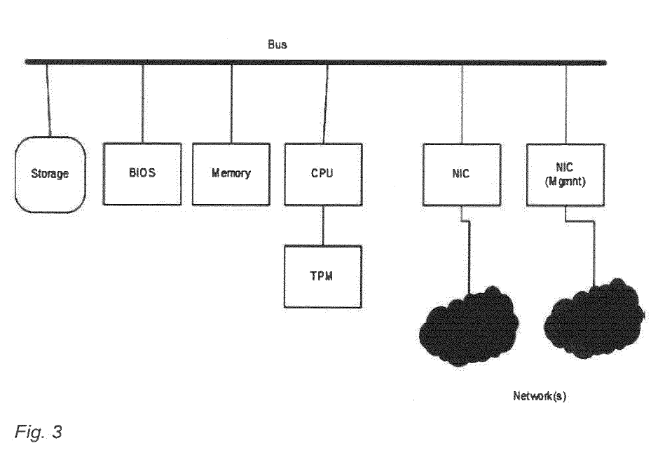

FIG. 2 illustrates an embodiment for a trust failure alert between a communication device, e.g. computing device 102, and network element of a communication system, e.g. a network node 101.

Referring to FIG. 2, the communication device (such as the computing device 102) detects (block 201) a failure of a trusted boot procedure of the computing device 102. In response to the detecting, the computing device 102 transmits (block 202) a trust failure message via a network, wherein the trust failure message 202 is generated (block 201), in the computing device 102, by utilizing a launch control policy (LCP) of a trusted platform module (TPM) to integrate the trust status of the computing device 102 into the trust failure message 202, without booting the computing device 102. The network element (such as network node 101 (which may comprise e.g. a management and operations MANO node 101)) monitors (block 203) network communication of communication devices (such as computing device 102) and receives (block 203) the trust failure message 202. In response to the receiving 203, the network node 101 reacts 206 to the failure of the trusted boot procedure. There are various options/alternatives how the network node 101 reacts 206 to the failure of the trusted boot procedure.

In an embodiment, the reacting comprises providing 206 information from the network node 101 (or specific component within the network node 101) that a trust failure has occurred (and possibly information on the characteristics of the trust failure in some detail). Thus the network node 101 (or the specific component within the network node 101) may send information on the trust failure (e.g. via an Or-Nf interface, Vi-So interface or Or-Vi interface to an orchestrator node, or some other network element).

In an embodiment, the reacting may comprise checking 204 and con-firming 205 the failure of the trusted boot procedure by directly calling the computing device 102 or by calling remote attestation (i.e. the network node 101 may request 204 the computing device 102 to confirm 205 whether or not the trust failure has actually occurred; this is an information gathering effort by the network node 101, and further reacting may be required).

In an embodiment, the reacting comprises informing 206 a VNF manager that selected functionalities of the computing device 102 are unavailable.

In an embodiment, the reacting may comprise running, in the computing device 102, a launch control policy code for halting the trusted boot procedure at a selected stage. Thus LCP runs or causes to run a code that generates a failure report and communicates this via a NIC or MNIC. The system may be halted in such a way that remote attestation or detection by other means is no longer possible due to specific services and hardware being made unavailable.

In an embodiment, the reacting comprises preemptively denying 207 communication with the computing device 102, other than communication related to remote attestation and/or failure diagnoses via a secured route.

In an embodiment, the reacting comprises a combination of one or more of the above options for reacting.

In an embodiment, the capabilities of the launch control policy enable generating alerts, e.g. via the network, such that the running untrusted machine 102 does not have to boot, but it may still be announced that a failure of the trusted boot procedure has occurred. Such a failure is typically announced via a normal network connection via a network port (which may comprise a network interface card, a management interface card, or any other suitable means, e.g. a serial connection, etc.), and picked up by a designated security component (possibly found in the network node (such as MANO) 101, e.g. a cloud security director or a security orchestrator) or similar. Required actions may be carried out in a general-purpose computing element or storage element, or in a specific-purpose computing element or storage element such as in an SDN controller. The launch control policy of TPM may be utilized to announce the trust status by integrating the trust failure report into a predefined or hardcoded (thus, safe) message which may be relayed safely over the network (either the normal network or a management network, e.g. the management ports provided by some hardware). For example, a predefined mechanism may be provided for authentication and integrity protection of the trust failure message 202. This allows the announcement on the trust failure to be made without booting the machine. Such announcements may be picked up by management and operations (e.g. MANO) and dealt with accordingly. Furthermore, such trust failure announcement messages may also be picked up by network elements such as SDN, and the messages may be further routed and/or the network element may be restricted in some manner, e.g. by using network isolation and/or by causing additional protection measures (such as VNF wrapping, honey-potting, using specific routing structures, etc.).

In an embodiment, LCP including the alert is integrated in the components of the cloud environment without having to boot the machine 102 to an unknown state. A protocol is able to carry information on the trust failure either in a direct or broadcast manner, e.g. over UDP, TCP, ICMP, IP, etc. as required. The cloud environment MANO (such as network node 101) is able to react to the trust failure in a suitable manner. Additional functionality may be included in MANO 101 (or in another suitable network element) for handling the receipt and the subsequent processing of the trust failure message. Additionally, a mechanism within other network elements, such as SDN switches/controllers, is capable of delegated handling of the trust failure message. Additionally, a mechanism is provided for protecting the machine 102 which may have failure trust measurement at a later stage of boot, e.g. detection by remote attestation. Both dynamic and static root of trust may be used; in the former the measurements are taken at once, while in the latter the boot proceeds stage-by-stage as each lower layer is first measured and checked.

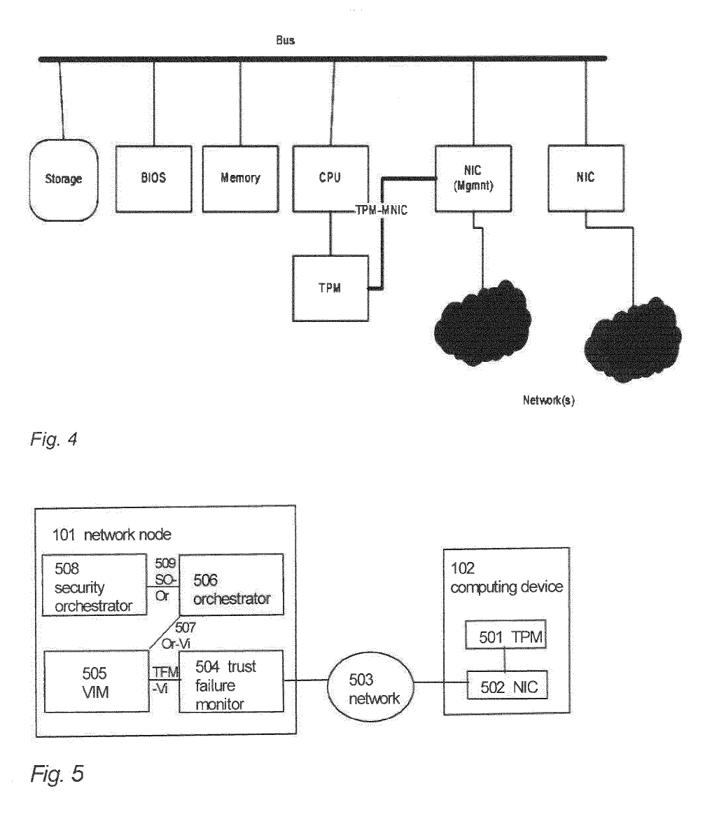

FIG. 3 illustrates a simplified computer architecture with BIOS, CPU, TPM, NIC (network interface card), management NIC (if present), and storage. TPM comprising PCR registers and NVRAM comprising the launch control policy. An existing prior art measured boot process may proceed as follows. The network elements (such as a computing device) are checked, and the hashes of the network elements are generated. The generated hashes are checked against relevant values in PCRs in TPM. If a hash does not match, the launch control policy procedure is called. If no launch control policy is present, TPM halts the whole boot procedure. If a launch control policy is present, the launch control policy is run. The structure of the launch control policy typically involves calling a given executable program code with parameters, and optionally calling a command. The executable code to be called is an operating system image to be run. For example, the image may be called in such a way that various features of the operating system remain disabled, e.g. no networking or reduced functionality, such as instructions to keep file systems in a read-write or text-only mode (no GUI start), etc. It is not necessary to have LCP present, though if not present then a default policy is used. Typically, the default policy does not halt boot. Most LCPs are simple ‘halt-on-failure’ policies.

An embodiment involves a modified launch control procedure in case of a trust measurement failure, wherein a trust failure message is broadcast to a receiver, after which actions (such as reactions described above in connection with FIG. 2 (e.g. in items 204, 205, 206 and/or 207)) may take place. If the trust measurement fails during the boot process of a network element, such as the computing device 102, the launch control policy may be utilized. This includes noting the particular PCR that failed. This gives information on the component of the computing device 102 that failed the trust measurement, e.g. BIOS, host O/S, etc. The procedure for the measurement failure announcement may be as follows. In case of failure of the trust measurement against PCR, LCP is called. LCP then calls an executable piece of program code which is then run. The executable code generates a trust failure message detailing the cause of the failure and sends the message to the network interface card (or cards) of the computing device 102. NIC/NICs broadcast the trust failure message including the cause of the failure by using a selected protocol. The message is received by one or more listening network nodes 101, e.g. by a trust failure protocol listener component (trust failure monitor) attached to the cloud environment MANO 101. MANO 101 orchestrates a response accordingly.

At this stage, LCP may be configured such that booting of the computing device 102 continues (with caveats) as required. If the booting continues, a suitable delay may be included to allow the network node 101 (i.e. MANO and/or other management operations) time to respond or prepare a response to the report of the measurement failure. The protocols being used may be broadcast protocols. At this stage of the booting the untrusted machine 102 (i.e. the computing device 102) has not received an IP address (this may not be true for management interfaces) of the network node 101, and so a broadcast address is likely to be used. The trust failure message may, however, include the MAC address of the computing device 102 such that the computing device 102 is identifiable. Procedures for temporarily obtaining IP addresses, e.g. ARP stuffing, may also be used. The choice of direct communication vs. broadcast communication is one of the security features available. (In prior art systems, the choice was programmed into TPM where an agent required for receiving the messages may be present). This may complicate the situation, since the agent's location may not be known with certainty, and that may put extra demand on the network protocols, e.g. the necessity of obtaining the IP address, etc. In a broadcast mode the whole network is announced that a trust failure has occurred, wherein everybody potentially sees the failure announcement. However, this case does allow delegated actions to take place. A further issue with broadcasting is the routability of net-work traffic. Routing broadcast data/non-routable traffic may require the switches to be aware of such traffic and the nature of the traffic. If a ‘conversation’ is required between the computing device 102 and MANO 101, then the setup of direct two-way communication is required, which is not possible to be provisioned by broadcast alone.

An embodiment involves storing the program code that is to be executed by LCP and the options that are available. Another option is that specific signed code is available in the system's normal file system, or pre-programmed into BIOS, etc. Such code may only run while CPU is placed into a specific secure mode. Such secure modes or their equivalents (SINIT . . . SENTER . . . SEXIT) are implemented by Intel and AMD processors and utilized during the trusted or measured boot procedure. This is a mechanism by which CPU is able to execute code securely during a trust failure. The amount of NVRAM on TPM available for storing LCP is severely limited in existing TPM implementations, e.g. 1280 bytes may be typical. It may be possible to increase the amount of memory such that more information, e.g. a file system, is stored. Thus a full (trusted) operating system may be stored in NVRAM and called by LCP. TPM may additionally be connected directly to NIC or MNIC, such that TPM is able to call NIC (or MNIC) directly, either by means of the above embedded operating system or through some extension to LCP, or via any other secure means as described above. One possibility is to extend the secure code supplied as part of the trusted boot procedure to handle some or all of the functionality. Thus, in case of a trust failure, the code may be run from any suitable network location. The trust failure announcement over the network may then proceed as described above without the use or booting of any other executable codes which may have been compromised. The direct TPM connection to NIC is illustrated in FIG. 4 by means of a TPM-MNIC interface which provides direct access to the NIC functionality from TPM. The TPM-MNIC interface does not necessarily have to be connected to the management NIC (if present), but the TPM-MNIC interface may be connected to any NIC. In another option, when LCP is called, LCP requests a PXE boot (net-work boot) such that a custom image is loaded from some trusted network source, and the boot of the computing device then continues with the custom image rather than one supplied on the disk. Thus it is achieved that some kind of an operating system is able to run in a trust failure situation.

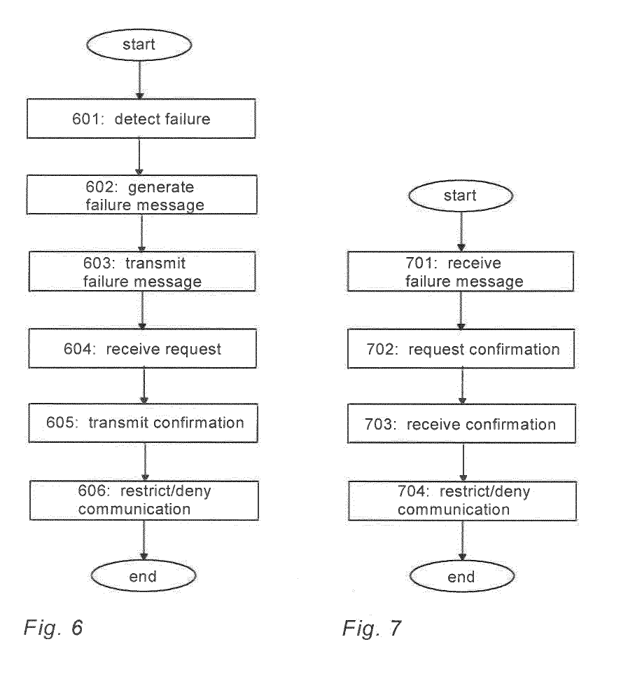

FIG. 5 is a block diagram illustrating exemplary apparatuses. The trust failure message that is to be broadcast, only needs to contain information on that a trust failure has occurred. This may be achieved by the message's existence and a machine address given by the protocol used to carry the message, e.g. the MAC address of the reporting computing device. Further refinements of the trust failure message may be made, e.g. obtaining a temporary IP address by using ARP stuffing, or DHCP may be employed, or announcing the trust failure message over the management plane or control plane interfaces which may already have an IP address provided. The trust failure message may be broadcast or sent directly to the component that is capable of receiving such a trust failure message. FIG. 5 illustrates such a component, however, a security orchestrator 508 or orchestrator 506 may also host such functionality. While a plain announcement may be sufficient, additional information may be included by the protocol. The additional information may include, for example, information on one or more of the identification of the PCR register or registers that have failed the measurement, the contents of the PCR register or registers that have failed the trust measurement, the trust measurement results on what caused the trust failure, machine metadata (including a BIOS version etc.), a TPM version, soft-ware version numbers, hardware version numbers, software identification numbers, hardware identification numbers, static root-of-trust status, and dynamic root-of-trust status.

Referring to FIG. 5, a computing device 102 with TPM 501 may fail a trust measurement, wherein TPM 501 communicates (e.g. by specific kernel load, direction connection to NIC 502, etc.) the trust failure message to be broadcast over the network 503. NIC 502 may connect to the network, and broadcast or directly send the trust failure message to a network node 101. The network infrastructure may comprise e.g. a virtual network, Ethernet, serial port, etc. The network node 101 may be a management and orchestration component MANO for the cloud infrastructure. A trust failure monitor 504 may either monitor or directly receive communication from the machine 102 that the trust measurement of the machine 102 has failed. The trust failure monitor component 504 may be integrated in VIM 505 or other suitable component within MANO 101. The trust failure monitor component 504 may also exist outside of MANO 101 as an independent network element or even form a part of an integrity or attestation component, e.g. Intel's CIT. VIM 505 refers to a functionality defined by an ETSI-NFV reference architecture. VIM 505 may communicate to an orchestrator 506 via an Or-Vi interface 507 (or use any other routing if necessary). The orchestrator 506 is responsible for overall planning of the cloud infrastructure. The orchestrator component 506 may be required to understand how to allocate machines, trusted VNFs etc. as necessary. A security orchestrator 508 may provide additional policies and information to the orchestrator 506 (or any component requesting) as necessary on how to handle security implications of the trust failure. The Or-Vi interface 507 comprises an interface through which VIM 505 and the orchestrator 506 are able to communicate.

Thus, in an embodiment, for reacting to the trust failure message in MANO 101, MANO 101 includes a number of components as defined by ETSI, such as VIM 505, though depending on the implemented architecture, any other component may be used, ostensibly following the role of VIM 505 as defined by ETSI. An additional component 504 within or in addition to VIM 505 may monitor trust failure announcements or events in the network 503 and report the trust failure announcements and/or events to VIM 505. VIM 505 then communicates the trust failure announcements and/or events ‘upwards’ within a MANO stack via the Or-Nf or Or-Vi interfaces 507 (as necessary) to the orchestrator 506. The orchestrator 506 then has the responsibility to marshalling existing VNFs, SDN controllers etc. as necessary as a reaction to the trust failure announcement. It is possible that a direct connection to the security orchestrator 508 through a Vi-So interface 509 is also provided, depending on an actual internal construction of MANO 101 and abstraction layers within MANO 101. A VNF manager component may ostensibly be located between VIM 505 and the orchestrator 506 (mentioned above with reference to the Or-Nf interface). The VNF manager may be utilized depending on where the trust failure occurred, e.g. late in boot versus early in boot. VIM 505 itself may have the above functionality already embedded within (depending on the implementation). VIM 505 may have the above functionality already embedded within even if such monitoring was carried out higher up in the MANO stack. The monitoring component 504 may be part of any security orchestration component (e.g. security orchestrator 508 or cloud security director) rather than being a component of the MANO stack itself. Again this is an implementation option, but in this case the security orchestration component has the responsibility for alerting MANO 101 to the failure of trust. In the previous case it is possible that as part of the MANO's re-action, VIM 505 additionally confirms or checks the trust failure either by directly calling the affected machine 102—if possible—or by calling remote attestation to assess the situation. In every case, the remote attestation (e.g. provided by Intel's CIT or OpenAttestation) may be called to make an additional check. How-ever, such remote attestation may only work in cases where a network connection 103 to the affected machine 102 is available. Such a network connection 103 may not become available, if LCP prevents the machine 102 from booting to such a state. There are possibilities to utilise the management network if available, however, this may introduce additional security risks as the management functionalities may have been compromised, if the trust failure has occurred in the affected machine's BIOS, for example.

In an embodiment, the reacting in MANO 101 to the trust failure message may be directed to any number of places. The place may be chosen depending on at which stage the trust failure occurred and/or which PCR registers failed the trust measurement. For example, if the trust failure occurs at run-time, then the failure announcement message may be triggered by the remote attestation. TPM is rarely invoked at run-time directly, but if it is, then the following also applies as it does in the remote attestation case. The trust failure message may be propagated to the VNF manager as well as to the orchestrator 506 and any security orchestrator 508. Run-time attestation is possible with a modification to TPM 501 either in hardware or to the operating system/BIOS. Currently, run-time attestation, if it occurs at all, is carried out by remote attestation. If the trust failure occurs at boot-time (which is more likely) and if the trust failure occurs at BIOS (as dictated by the PCR register), then the VNF manager is not likely to be invoked as no VNFs are running at this time. Similarly a trust failure in a certain host operating system component does not invoke the VNF manager. If the trust failure occurs late in the boot sequence, e.g. during checking of the hypervisor environment, then the VNF manager may have to be informed that certain functionalities are not available, for example, trusted pools for running trusted VMs (and their VNFs). Similar cases may be established for geographical trust failures too.

An embodiment is related to a MANO-directed failure report, wherein LCP runs a code that halts the boot process of the computing device 102 at a suitable point, communicates that a trust failure has occurred, and then waits for a more specific response from MANO 101. This may require that two-way communication is set up (with necessary security) between the network node 101 and the computing device 102, which is only possible after initial broadcast communication and secured communication channel setup.

In an embodiment, monitoring of the trust failure messages may be carried out by other network elements such as SDN switches and routers. In this case, it is possible that the reacting to the trust failure may be delegated, and the network preemptively isolates the affected machine 102. This may allow se-cured routes to the machine 102 for remote attestation and diagnoses. A switch or a router may be configured via flow tables, for example, to react to the trust failure announcements or events, and forward the event to a more suitable component, e.g. to the security orchestrator 508. The delegated reaction on the trust failure may also be used to handle non-routable failure announcement protocols. The switch or router may directly contact its SDN controller for instructions such as instructions for isolating the particular machine 102. The switch or router may introduce additional filtering and routing to filters such as honey-pots, malware detection, etc. such that the machine 102 may be allowed to boot normally, but the overall network configuration is protected from the potentially infected/damaged machine 102. This latter case may involve additional orchestration from any security orchestration and MANO components to invoke additional VMFs to provide the monitoring and analysis functionality.

In an embodiment, the TPM-NIC interface in the computing device 101 may be a virtual interface in the sense that the TPM-NIC interface may be realized via CPU and a bus in accordance with computing device communication. Alternatively/in addition to the TPM-NIC interface, the computing device 101 may comprise a TPM-MNIC interface that may be a virtual interface (i.e. realized via CPU and the bus in accordance with the computing device communication). The TPM-MNIC and/or TPM-NIC interfaces may also be implemented as physical interfaces. The decision on which interface to use may be made based on the launch control policy of TPM, for example.

Thus, an embodiment enables managing high-integrity and trusted computation and workloads in a computing environment such as a cloud computing, telcocloud, server farm, etc. When the machine boots, various elements are checked against TPM's preconfigured/stored values. If TPM detects an incorrect value against one (or more) of its PCR registers then LCP is called (potentially for that individual value). LCP then causes an alert to be send via NIC or similar (e.g. RS232 port, M-NIC, via a remotely received, e.g. by PXE booted kernel, by local designed kernel etc.) detailing the failure. LCP may allow the boot to continue (with potential for further failures) or halt the system. Either way the system is now untrusted (even if it is allowed to complete the boot cycle and run normally).

An embodiment provides an apparatus comprising at least one processor and at least one memory including a computer program code, wherein the at least one memory and the computer program code are configured, with the at least one processor, to cause the apparatus to carry out the procedures of the above-described computing device or network node. The at least one processor, the at least one memory, and the computer program code may thus be considered as an embodiment of means for executing the above-described procedures of the computing device or the network node. FIGS. 8 and 9 illustrate block diagrams of a structure of such an apparatus. The apparatus may be comprised in the computing device (FIG. 8) or in the network node (FIG. 9), e.g. the apparatus may form a chipset or a circuitry in the computing device or in the network node. In some embodiments, the apparatus is the computing device (FIG. 8) or the network node (FIG. 9). The apparatus comprises a processing circuitry 10, 50 comprising the at least one processor.

The processing circuitry 10 may comprise a trust failure detector 12 configured to detect a failure of a trusted boot procedure of the computing device. The trust failure detector 12 may be configured to indicate the detecting to a control message generator 14 configured to generate and transmit a trust failure message, by utilizing a launch control policy of a trusted platform module, via a network, to integrate the trust status of the computing device into the trust failure message.

The processing circuitry 50 may comprise an interface 52 configured to receive, via a network, a trust failure message, the trust failure message being generated in a computing device when detecting a failure of a trusted boot procedure of the computing device and by utilizing a launch control policy of a trusted platform module to integrate the trust status of the computing device into the trust failure message. The interface may be configured to indicate the received trust failure message to a failure reaction circuitry 54 configured to react in an appropriate way (as described above in connection with FIG. 2, for example) to the failure of the trusted boot procedure of the computing device.

The processing circuitry 10, 50 may comprise the circuitries as sub-circuitries, or they may be considered as computer program modules executed by the same physical processing circuitry. The memory 20, 60 may store one or more computer program products 24, 64, respectively, comprising program instructions that specify the operation of the circuitries. The memory may further store a database 26, 66, respectively, comprising definitions for the trust failure procedure, for example. The apparatus may further comprise an interface 16, 52, respectively, providing the apparatus with fixed, wireless, or radio communication capability. The interface may comprise a radio communication circuitry enabling wireless communications and comprise a radio frequency signal processing circuitry and a baseband signal processing circuitry. The baseband signal processing circuitry may be configured to carry out the functions of a transmit-ter and/or a receiver. In some embodiments, the interface may be connected to a remote radio head comprising at least an antenna and, in some embodiments, radio frequency signal processing in a remote location with respect to the base station. In such embodiments, the radio interface may carry out only some of radio frequency signal processing or no radio frequency signal processing at all. The connection between the interface and the remote radio head may be an analogue connection or a digital connection. In some embodiments, the interface may comprise a fixed communication circuitry enabling wired communications.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

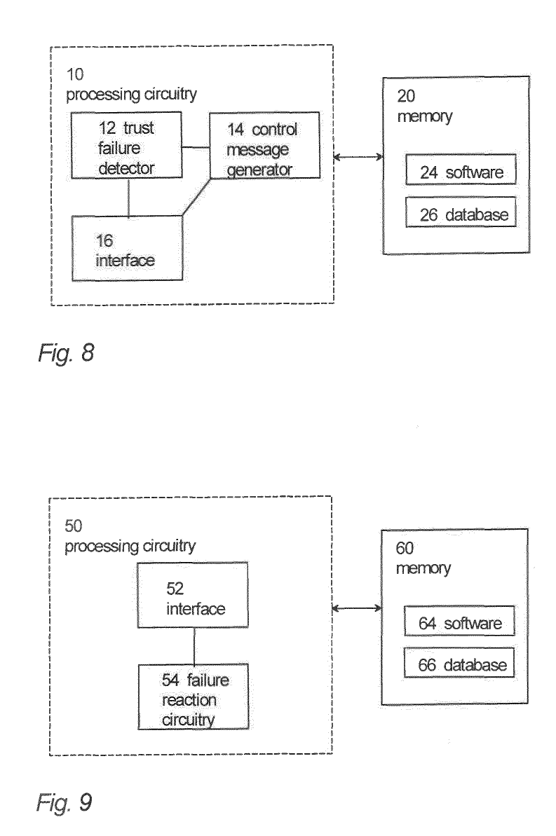

FIGS. 6 and 7 illustrate exemplary processes for the failure trust alert according to an embodiment of the invention.

Referring to FIG. 6, the communication device (such as the computing device 102) detects (block 601) a failure of a trusted boot procedure of the computing device 102. In response to the detecting, the computing device 102 transmits (block 603) a trust failure message via a network, wherein the trust failure message is generated (block 602), in the computing device 102, by utilizing a launch control policy (LCP) of a trusted platform module (TPM) to integrate the trust status of the computing device 102 into the trust failure message, without booting the computing device 102.

There are various options/alternatives how the network node 101 reacts to the failure of the trusted boot procedure. The reacting may comprise checking 604 and confirming 605 the failure of the trusted boot procedure (i.e. the computing device 102 may be requested 604 to confirm 605 whether or not the trust failure has actually occurred). The reacting may comprise running 606, in the computing device 102, a launch control policy code for halting the trusted boot procedure at a selected stage. Thus LCP runs or causes to run a code that generates a failure report and communicates this via a NIC or MNIC. The system may be halted in such a way that remote attestation or detection by other means is no longer possible due to specific services and hardware being made unavailable. The reacting may comprise preemptively denying 606 communication with the computing device 102, other than communication related to remote attestation and/or failure diagnoses via a secured route. The reacting may comprise a combination of one or more of the above options for reacting.

Referring to FIG. 7, the network element (such as network node 101 (which may comprise e.g. a management and operations MANO node 101)) monitors (block 701) network communication of communication devices (such as computing device 102) and receives (block 701) the trust failure message 202. In response to the receiving 701, the network node 101 reacts 702, 704 to the failure of the trusted boot procedure. There are various options/alternatives how the network node 101 reacts to the failure of the trusted boot procedure.

The reacting may comprise providing 704 information from the net-work node 101 (or specific component within the network node 101) that a trust failure has occurred (and possibly information on the characteristics of the trust failure in some detail). Thus the network node 101 (or the specific component within the network node 101) may send information on the trust failure (e.g. via an Or-Nf interface, Vi-So interface or Or-Vi interface to an orchestrator node, or some other network element). The reacting may comprise checking 702 and confirming 703 the failure of the trusted boot procedure by directly calling the computing device 102 or by calling remote attestation (i.e. the network node 101 may request 702 the computing device 102 to confirm 703 whether or not the trust failure has actually occurred; this is an information gathering effort by the network node 101, and further reacting may be required). The reacting may comprise informing 704 a VNF manager that selected functionalities of the computing device 102 are unavailable. The reacting may comprise causing 704 the computing device 102 to run a launch control policy code for halting the trusted boot procedure at a selected stage. Thus LCP runs or causes to run a code that generates a failure report and communicates this via a NIC or MNIC. The system may be halted in such a way that remote attestation or detection by other means is no longer possible due to specific services and hardware being made unavailable. The reacting may comprise preemptively denying 704 communication with the computing device 102, other than communication related to remote attestation and/or failure diagnoses via a secured route. The reacting may comprise a combination of one or more of the above options for reacting.

The processes or methods described above in connection with FIGS. 1 to 9 may also be carried out in the form of one or more computer process defined by one or more computer programs. The computer program shall be considered to encompass also a module of a computer programs, e.g. the above-described processes may be carried out as a program module of a larger algorithm or a computer process. The computer program(s) may be in source code form, object code form, or in some intermediate form, and it may be stored in a carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to fixed, wired, wireless, cellular or mobile communication systems defined above but also to other suitable communication systems. The protocols used, the specifications of cellular communication systems, their network elements, and terminal devices develop rapidly. Such development may require extra changes to the described embodiments. Therefore, all words and expressions should be interpreted broadly and they are intended to illustrate, not to restrict, the embodiment.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

TPM trusted platform module
BIOS basic input output system
UEFI unified extensible firmware interface
CIT cloud integrity technology
MANO management and operations
SDN software defined networking
LCP launch control policy
NIC network interface card
MNIC management network interface card
CPU central processing unit
TCP transmission control protocol
UDP user datagram protocol
ICMP internet control message protocol
PCR platform configuration register
NVRAM non-volatile random access memory
O/S operating system
VIM virtual infrastructure manager
CSD cloud security director
VM virtual machine
VNF virtual network function
SNA systems network architecture

1. A computerized method for announcing that a failure of a trusted boot procedure has occurred, the method comprising performing, in a computing device, the steps of
detecting a failure of a trusted boot procedure of the computing device; and
in response to the detecting, transmitting a trust failure message via a network, wherein the trust failure message is generated, in the computing device, by utilizing a launch control policy of a trusted platform module to integrate the trust status of the computing device into the trust failure message.

2. The method of claim 1, wherein the trust failure message is pre-defined, hardcoded or generated in the computing device.

3. The method of claim 1, wherein the trust failure message is transmitted, from the computing device, by utilizing a direct or broadcast protocol.

4. The method of claim 1, wherein the failure of the trusted boot procedure is detected, in the computing device, by means of a trust measurement at a later stage of the boot procedure, such as by remote attestation.

5. The method of claim 1, wherein the trust failure message is transmitted, from the computing device, via a management network.

6. The method of claim 1, wherein the failure of the trusted boot procedure is detected, in the computing device, based on a dynamic root of trust by carrying out trust measurements on the boot procedure at once.

7. The method of claim 1, wherein the failure of the trusted boot procedure is detected, in the computing device, based on a static root of trust by carrying out trust measurements on the boot procedure stage-by-stage as each lower layer is first measured and checked.

8. The method of claim 1, wherein the launch control policy is integrated into a cloud environment component.

9. The method of claim 1, wherein the trust failure message comprises an address of the computing device, such a MAC address or temporary IP address of the computing device.

10. The method of claim 1, wherein the trust failure message comprises information on one or more of an identification of a platform configuration register that failed the trust measurement, contents of the platform configuration register that failed the trust measurement, failed trust measurement results, computing device meta-data, trusted platform module version, software version, hardware version, software identification, hardware identification, static root-of-trust status, and dynamic root-of-trust status.

11. The method of claim 1, wherein the method further comprises running, in the computing device, a launch control policy code for halting the trusted boot procedure at a selected stage.

12. A computerized method for announcing that a failure of a trusted boot procedure has occurred, the method comprising performing, in a network node, the steps of
receiving, via a network, a trust failure message, the trust failure message being generated in a computing device when detecting a failure of a trusted boot procedure of the computing device and by utilizing a launch control policy of a trusted platform module to integrate the trust status of the computing device into the trust failure message; and
reacting to the failure of the trusted boot procedure.

13. The method of claim 12, wherein the trust failure message is transmitted by utilizing a direct or broadcast protocol.

14. The method of claim 12, wherein the trust failure message is transmitted via a management network.

15. The method of claim 12, wherein the trust failure message comprises an address of the computing device, such a MAC address or temporary IP address of the computing device.

16. The method of claim 12, wherein the trust failure message comprises information on one or more of an identification of a platform configuration register that failed the trust measurement, contents of the platform configuration register that failed the trust measurement, failed trust measurement results, computing device meta-data, trusted platform module version, software version, hardware version, software identification, hardware identification, static root-of-trust status, and dynamic root-of-trust status.

17. The method of claim 12, wherein the method further comprises reporting the trust failure messages via an Or-Nf interface, Vi-So interface or Or-Vi interface to an orchestrator node.

18. The method of claim 12, wherein the method further comprises, in the network node, checking and confirming the failure of the trusted boot procedure by directly calling the computing device or by calling remote attestation.

19. The method of claim 12, wherein the reacting is directed to a component of the computing device, chosen depending upon at which stage the failure of the trusted boot procedure occurred or which PCR register failed a trust measurement.

20. The method of claim 12, wherein the reacting comprises informing a VNF manager that selected functionalities of the computing device are unavailable.

21. The method of claim 12, wherein the method further comprises causing, in the network node, the computing device to run a launch control policy code for halting the trusted boot procedure at a selected stage.

22. The method of claim 12, wherein the reacting comprises pre-emptively denying communication with the computing device, other than communication related to remote attestation or failure diagnoses via a secured route.

23. An apparatus comprising:
at least one processor; and
at least one memory including a computer program code, wherein the at least one memory and the computer program code are configured, with the at least one processor, to cause the apparatus to
detect a failure of a trusted boot procedure of a computing device; and
in response to the detecting, transmit a trust failure message via a network, wherein the trust failure message is generated by utilizing a launch control policy of a trusted platform module to integrate the trust status of the computing device into the trust failure message.

24. The apparatus of claim 23, wherein the trust failure message is pre-defined, hardcoded, or generated in the computing device.

25. An apparatus comprising:
at least one processor; and
at least one memory including a computer program code, wherein the at least one memory and the computer program code are configured, with the at least one processor, to cause the apparatus to
receive, via a network, a trust failure message, the trust failure message being generated in a computing device when detecting a failure of a trusted boot procedure of the computing device and by utilizing a launch control policy of a trusted platform module to integrate the trust status of the computing device into the trust failure message; and
react to the failure of the trusted boot procedure.

26. The apparatus of claim 25, wherein the trust failure message is transmitted by utilizing a direct or broadest protocol.

27. A computer system, where the system is configured to
detect, in a computing device, a failure of a trusted boot procedure of the computing device;
in response to the detecting, transmit a trust failure message via a network, wherein the trust failure message is generated, in the computing device, by utilizing a launch control policy of a trusted platform module to integrate the trust status of the computing device into the trust failure message;
receive the trust failure message in a network node; and
in response to the receiving, react to the failure of the trusted boot procedure.

28. The system of claim 27, wherein the trust failure message is pre-defined, hardcoded, or generated in the computing device.

29. A computer program product embodied on a non-transitory distribution medium readable by a computer and comprising program instructions which, when loaded into an apparatus, execute the method according to claim 1.

31. A computer program product embodied on a non-transitory distribution medium readable by a computer and comprising program instructions which, when loaded into the computer, execute a computer process comprising causing a network node to perform any of the method steps of claim 1.
